(19) United States
(12) Patent Application Publication
(10) Pub. No.: US 2006/0132713 A1
(43) Pub. Date: Jun. 22, 2006

(54) Discussion apparatus and method

(76) Inventor: Joseph R. Lemersal, Park Ridge, IL (US)

Correspondence Address: William J. Hallihan;HALLIHAN INTELLECTUAL PROPERTY LAW, LTD., Suite 2080, 125 S. Wacker Drive, Chicago, IL, 60606, US

(21) Appl. No.: 11/018,364

(22) Filed: Dec. 20, 2004

(51) Int. Cl. G03B 15/08

(52) U.S. Cl. 352/244

(57) ABSTRACT

A discussion apparatus and method is shown that is particularly useful for holding motion-picture discussion clubs and providing the members with the motion-picture that is the subject of an upcoming motion-picture discussion event. Copies of the motion-picture are made available to each of the club members using one or more methods of distribution. Topics of conversation are provided for each of the members to focus on for the motion-picture discussion event.

### BACKGROUND

One of the inventions disclosed herein relates to the field of apparatus and methods for conducting discussion groups, and more specifically, to apparatus and methods for conducting motion-picture discussion clubs.

Many people enjoy getting together with others for social aspects. In some cases, groups are formed for people having similar interests. For example, book clubs have been formed for people who enjoy reading so that they can get together and discuss a book that each member of the group has read.

Many people enjoy seeing motion-pictures, such as movies, tv shows, streaming video, shorts, etc. Some of these people enjoy recommending these motion-pictures to others and discussing portions of the motion-picture with others who have seen the same motion-picture.

Some people, such as immigrants for whom the predominant language is there second language, find it difficult to read or do not enjoy reading. Other people cannot read or do not have the time that it takes to read the books that are assigned by a book discussion group. Others may just not want to make the significant time commitment to read each assigned book if they do not find some of the assigned books to be very interesting.

Additionally, book discussion groups can suffer from the difficulty in each member obtaining copies of the assigned book if the book is expensive, not available at the library, or out of stock at the local bookstore. Indeed, particularly popular books may be sold out at several local bookstores and members may not be able to obtain a book in sufficient time by placing the book on order.

Therefore, a need exists for apparatus and methods to allow the easy formation and operation of a discussion group.

### SUMMARY

The disclosed apparatus and methods avoid some of the disadvantages of prior apparatus and methods while affording additional advantages.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a flow chart depicting one form of a system for providing motion-picture discussion club packets.

FIG. 2 is a block diagram of one form of the motion-picture discussion club packet.

FIG. 3 depicts the contents of one form of the host's manual of the motion-picture discussion club packet of FIG. 2.

FIG. 4 depicts the contents of one form of the club member's topic list of the motion-picture discussion club packet of FIG. 2.

FIG. 5 depicts the contents of one form of the written interpretive comments of the motion-picture discussion club packet of FIG. 2.

FIG. 6 is a flow chart depicting the steps of one form of producing motion-picture discussion club packets of FIG. 1.

### DETAILED DESCRIPTION

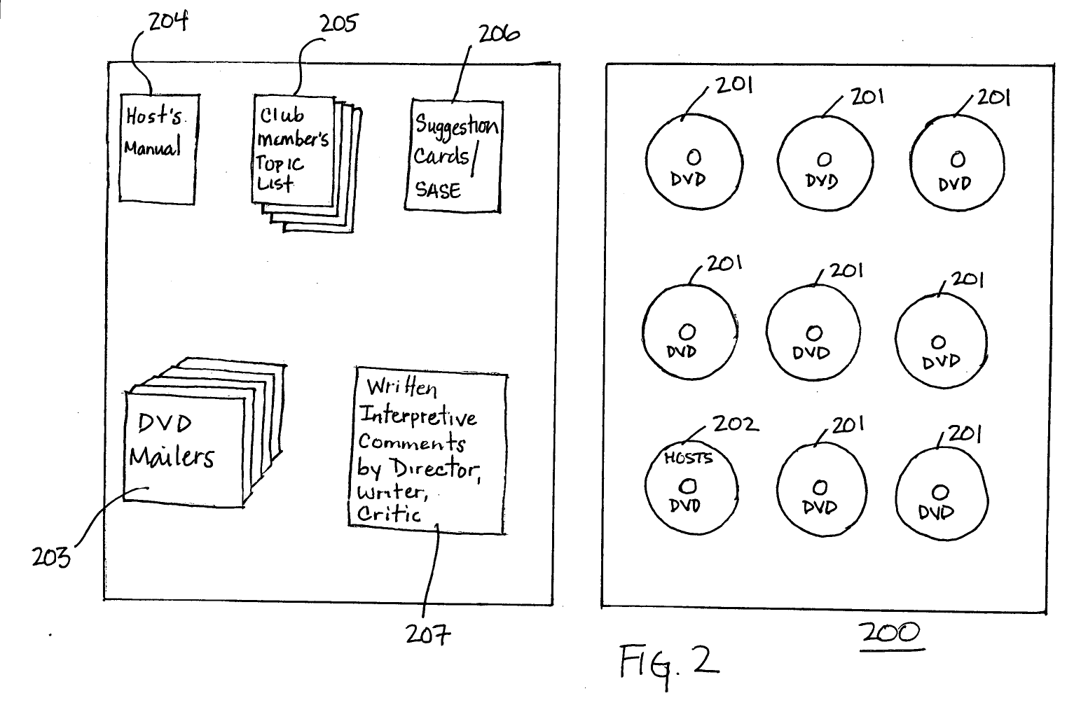

Referring to FIG. 2, there is shown one form of a Motion-picture Discussion Club Packet (MDCP) 200, such as a motion picture discussion event packet. Motion-picture Discussion Club Packet 200 includes a plurality (12, for example) of motion-picture media copies 201 and at least one discussion group media copy 202. Media copies 201 and 202 each contain a copy of the motion-picture that is the subject for a motion-picture discussion event. Host media copy 202 can also include additional information, such as interviews with the director, writer, actors or producer, and is often designed to be shown at the meeting of the motion-picture discussion club.

Media copies 201 and 202 can be any appropriate form of media that can be easily distributed, such as DVDs, VHS cassettes, VCDs, electronic files, electronic signals, etc. One or more of media copies (201 and/or 202), can be manufactured to allow only a single viewing, a set number of viewings, or unlimited viewings within a certain time period after activation. Such activation may occur, for example, automatically when the media copy is first viewed.

In some forms, where appropriate, the Motion-picture Discussion Club Packet 200 includes a distribution apparatus, such as DVD media mailers 203, that can be used by the host (or others) to distribute the media copies 201 to other members of a discussion club or participants in a scheduled motion-picture discussion. However, other forms of appropriate distribution apparatus can be used such as distributing electronic files of the motion-picture over a network, such as the Internet or an Intranet. In one form, emails can be sent that contain a link to a website from which the motion-picture can be downloaded. In another form, the club members could be notified of the motion-picture that will be the topic of the next meeting and the motion-picture distribution can involve each club member either renting a DVD or videotape, by downloading an electronic file of the motion-picture over the Internet or another network, ordering the motion-picture on a pay per view basis (or on-demand basis) on a cable network or satellite service, watching a scheduled showing of the motion-picture over the television airwaves, or any other appropriate method of distribution.

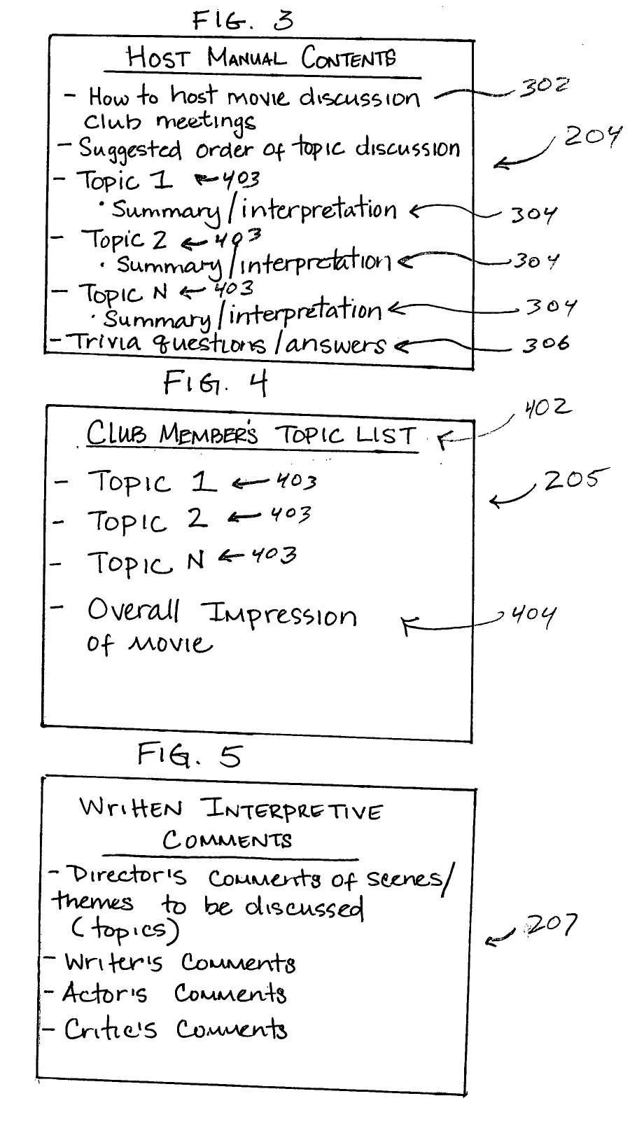

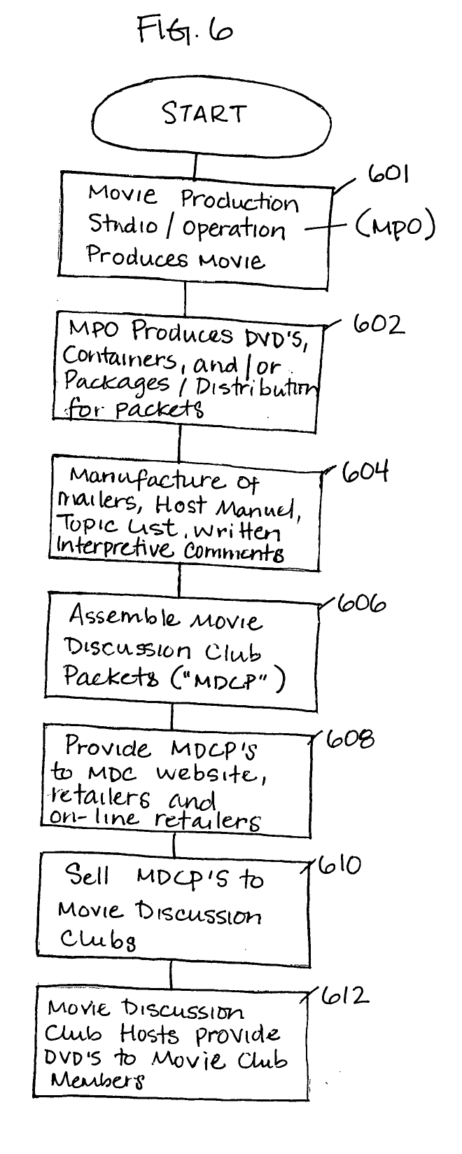

Referring also to FIGS. 3 and 4, a host manual 204 and club member's manual 205 can be provided in Motion-picture Discussion Club Packet 200. Club member's manual 205 can include a club member's topic list 402 and tips for preparing for, or making the most of, Motion-picture Discussion Club Packet. Topic list 205 can include a list of topics 403 regarding certain scenes, themes, characters or other aspects of the motion-picture for discussion. It can also include a record portion 404 where the member can record notes for later use at the meeting, such as recording notes responsive to the topics and/or the members overall impression of the motion-picture.

Host manual 204 can include instructions on how to host motion-picture discussion club meetings 302, which can include tips on successfully hosting a Motion-picture Discussion Club, tips on moving the meeting and conversations along, and tips to make the overall experience more enjoyable. Host manual 204 can also include at least some of the same or similar information as that found in the club member's manual or topic list 205, such as the same topics 403. Additionally, host manual 204 can include additional information for the club meeting, such as a list of trivia question and/or answers 306 about the motion-picture. Host manual 204 can also include a record portion for the host to record notes, such as summaries or interpretations 304 responsive to the topics 403. Alternatively or additionally, preprinted summaries or interpretations responsive to the topics 403 can be included in host manual 204.

Interpretive comments 207 can be included in the Motion-picture Discussion Club Packet 200. Interpretive comments 207 can include some by those involved in the making of the particular motion-picture, such as the director's comments, the writer's comments, the actor's comments. Critic's comments could also, or alternatively, be included. The various interpretive comments 207 may include an analysis of particular themes, and/or sections or scenes in the motion-picture. In one form, interpretive comments 207 could be written and included in Host Manual 204. In another form, the club member's manual or topic list 205 can also include these written interpretive comments 207. In yet another form, discussion group media copy 202 may include interpretive comments 207 in either a displayed written form or can include actual interviews of the individual's giving their interpretive comments 500. Alternatively, interpretive comments 207 can be a standalone document as shown in FIG. 2.

An opinion document 206 can be included in the Motion-picture Discussion Club Packet 200. The opinion card can include survey questions, questions asking for specific opinions, and or a space for entering an opinion on any subject that the person who fills out opinion document 206 desires. For example, opinion document 206 can request a person suggest other motion-pictures, such as movies or series episode, to make available in another Motion-picture Discussion Club Packet 200. In one form, opinion document 206 can include a pre-addressed postage paid mailing, such as a postcard or an envelope for returning the opinion document 206 to the manufacturer, seller or one of their agents. In another form, opinion document 206 can be a form on a webpage that a customer can fill out. In yet another form, opinion document 206 can be in the form of an electronic document, such as an email or an electronic file, that is provided to a customer.

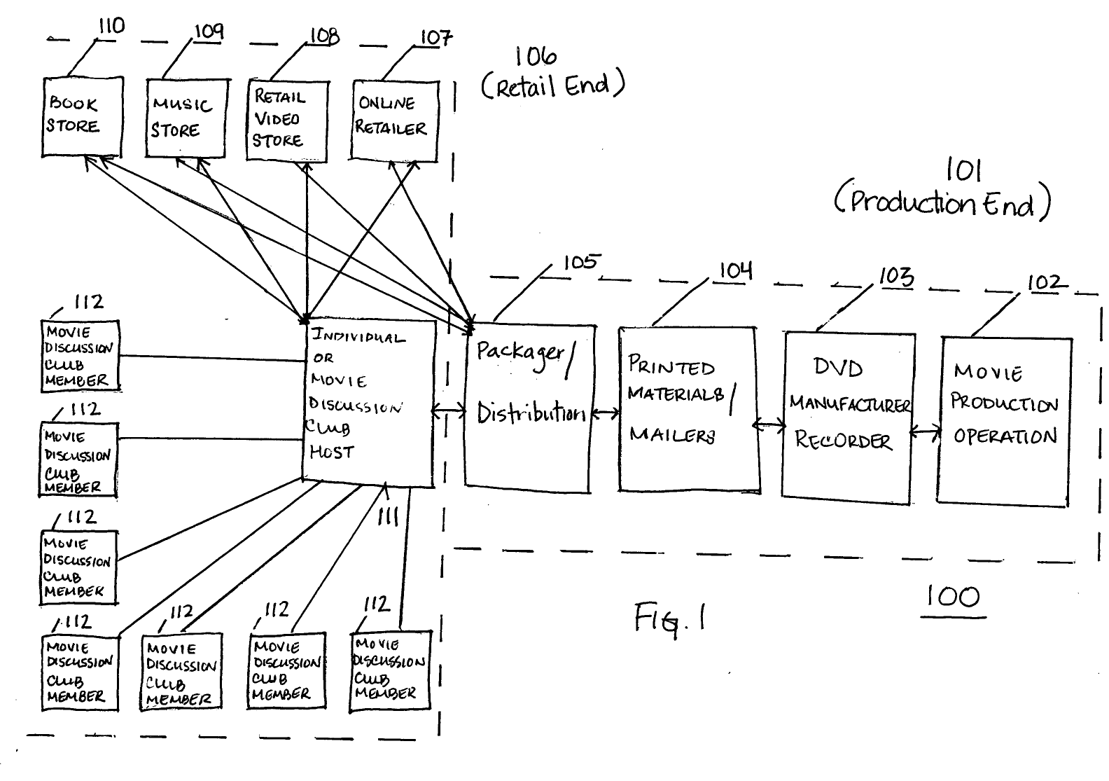

Referring to FIG. 1, there is shown a form of the manufacturing and/or distributing 100 a Motion-picture Discussion Club Packet 200. A production portion, or production end 101, includes a motion-picture production operation 102, such as any of the big movie production studios, that makes the actual motion-picture. The motion-picture then goes to a media manufacturer or a media recording entity (which can be the motion-picture production operation 101, such as DVD manufacturer or recorder 103, that makes copies of the motion-picture media copies 201 and the discussion group media copy 202. These media copies 201 and 202 include copies of the motion-picture that is the subject of the motion-picture discussion club packet 200. A printer (or publisher) prints (or publishes) the associated printed materials that are included with the discussion club packet 200. Such materials can include the manuals 204, 205, media mailers 203, opinion document 206, interpretive comments 207, and any artwork used on the media 201, 202 or on the packaging for the Motion-picture Discussion Club Packet 200. A packager/distributor 105 then packages and distributes Motion-picture Discussion Club Packet 200.

A retail portion, or retail end 106, is also provided. In one form motion-picture discussion club host 111, or an individual, can purchase or otherwise obtain the Motion-picture Discussion Club Packet 200 directly from the packager/distributor 105 (or even directly from the motion-picture production operation). Alternatively, discussion club host 111 can purchase or otherwise obtain the Motion-picture Discussion Club Packet 200 through various retail establishments, such as online retailers 107, retail video stores 108, music stores 109, and book stores 110. Club host 111 can then distribute media copies 201 to each of motion-picture discussion club members 112.

Referring to FIG. 6, there is shown a method of manufacturing and distributing the motion-picture discussion club packets 200. A motion-picture production studio produces 600 a motion-picture. Media copies 201, 202 containing the motion-picture are produced 602 and associated containers or packaging are also produced. Media mailers 203, manuals 204, 205, opinion documents 206 and/or interpretive comments 207 are written, published and/or printed 604. The motion-picture discussion club packets 200 are assembled 606. Then, motion-picture discussion club packets 200 are provided to motion-picture discussion club websites or individuals hosting a motion-picture discussion party through websites, retailers, on-line retailers, etc. 608. The motion-picture discussion club packets 200 are then sold to, purchased by, or otherwise made available to motion-picture discussion clubs and individuals hosting a motion-picture discussion party or event. The motion-picture discussion club host 111 makes media copies 201 available to motion-picture club members 112 at 612. In one form, club host 111 mails media copies 201 and manual 205 to club members 112 inside media mailers 203.

In another form, club host 111 can download electronic copies of the motion-picture over a network (such as the internet) from online retailer 107 and then distribute those copies over the same, or another, network by attaching a copy to an email and sending it to each club member 112. In one form, the club host 111 can distribute media copies 201 by sending emails including a link and/or code for downloading a copy of the motion-picture from the online retailer over a network.

In another form, the club host 111 can distribute media copies 201 by providing identifying information concerning each club member 112 and providing identifying information concerning the subject motion-picture to a commercial distributor or retailer, who then provides each club member with the ability to obtain a media copy 201 or view the motion-picture. For example, the email addresses of club members 112 could be provided to an online retailer, which then sends each an email with a link or password that allows the club member 112 to obtain a copy 201 (or access to a copy) of the motion-picture over the internet, cable network or satellite television network. Alternatively, identifying information, such as names and addresses of the club members 112, could be provided to a television network company, such as a cable network, which then allows each of the club members 112 to obtain access to an electronic copy of the motion-picture in a manner similar to a pay per view service or on demand service. In another form, identifying information of the club members 112 could be provided to a retail video store which could then be used to reserve (and/or prepay for) media copies (such as rental copies) of the motion-picture for each club member 112.

In one form, each club may have an account or other identifying information stored by a retailer, such as Netflix. Such retailer could be provided with updated information as new members join or old members leave. The club host 111 can then provide the retailer with the club identifying information and information identifying the subject motion-picture. The retailer can then provide each club member 111 a media copy of the subject motion-picture or access to a copy of the subject motion-picture, such as by mailing them a copy of a DVD. The club members 111 may then have to eventually return the media copy at some point.

In any form where a physical media copy is provided to each member for a limited period of time, such as through a video rental outlet like blockbuster or Netflix, the host may provide the retailer with a preference list of motion-pictures that are desired as the topic of a movie-discussion event. The video rental outlet (or other distributor) can then check to see if the appropriate number of copies of physical media are available for the first preference, then the second, nth, etc. until coming to the highest preference with the appropriate number of media copies available. Then the copies can be reserved for the members of the club. In one form, each member of the club could pick up a copy at the video rental outlet. In another form, the distributor would deliver a media copy to each member (from member identifying information provided by the host or from member identifying information stored on file). In a modified form involving chain video rental outlets, members identifying information and local video rental outlets or favorite video rental outlets are provided to the chain and the chain checks to see if the appropriate number of physical media are available at the neighborhood or favorite locations of each member. In other words, if each member has a different neighborhood or favorite location from each of the others, then each of such locations would only require one media copy for the particular individual in the neighborhood.

Typically, individuals would form a motion-picture discussion club to hold multiple motion-picture discussion parties or events, each typically involving a different motion-picture. However, it is also contemplated that only one party or event may occur for the particular motion-picture discussion club.

Typically, the club host 111 (or planner) and club members 112 (participants) would each watch the motion-picture that is the subject of the next motion-picture party or event. The club host 111 and club members 112 can then review the manuals 204 and/or 205 for instructions and to review the listed topics for discussion and make any notes. The club will then meet or otherwise communicate (such as telephonically, via email, posting on a website, etc.) to discuss the motion-picture or otherwise provide there comments and contribution to other club members. Normally, the club members will focus on the topics listed in the manuals 204 and/or 205. After this communication or meeting, the club members can then watch the host media copy 202 to learn, for example, whether their interpretation of the movie or a particular scene matches what the director intended to convey or what another person involved in the movie or a critic thought. Interviews with the director and any of these others can be included that contains a discussion or interpretation of the section or scenes on which the club members will be instructed to focus particular attention.

In one form, the motion-picture discussion club packets 200 can be marketed primarily to small clubs formed by individuals interested in viewing and then meeting to discuss classic and contemporary films. The motion-picture discussion club packets 200 could be offered for sale via a toll-free telephone number, a website or by purchase at retail outlets such as book stores (e.g. Borders, Barnes & Noble, Crown), Music stores (e.g. Tower Records, Musicland), video stores (e.g. Blockbuster, Hollywood Video) or on-line retailers (e.g. Amazon.com).

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A motion-picture discussion event packet comprising:
a motion-picture scheduled to be the topic of a motion-picture discussion event by a planner of the event;
a plurality of accesses to the motion-picture;
a plurality of accesses to a list of topics for discussion during the motion-picture discussion event, the topics being related to the motion-picture; and
a distribution apparatus providing at least one access for each of a plurality of participants in the motion picture discussion event.

2. The motion-picture discussion event packet of claim 1 further comprising at least one access to interpretive comments about the motion-picture.

3. The motion-picture discussion event packet of claim 2 wherein the interpretive comments includes interpretive comments by at least one of the members of the group consisting of a director of the motion-picture, a producer of the motion-picture, a writer of the screen-play for the motion-picture, a writer of a work on which the screen-play for the motion-picture is based, an actor in the motion-picture, and a motion-picture critic.

4. The motion-picture discussion event packet of claim 2 wherein the interpretive comments includes interpretive comments by at least one of person associated with the motion-picture.

5. The motion-picture discussion event packet of claim 5 wherein the interpretive comments includes interpretive comments by at least one of the members of the group consisting of a director of the motion-picture, a producer of the motion-picture, a writer of the screen-play for the motion-picture, a writer of a work on which the screen-play for the motion-picture is based, and an actor in the motion-picture.

6. The motion-picture discussion event packet of claim 1 wherein the distribution apparatus further comprises a plurality of media mailers for distributing media copies of the motion-picture to the plurality of participants.

7. The motion-picture discussion event packet of claim 1 wherein the distribution apparatus further comprises information identifying the plurality of participants and a commercial distributor of the motion-picture that provides access, to the motion-picture, to the plurality of participants.

8. The motion-picture discussion event packet of claim 7 wherein the distribution apparatus further comprises a network through which the commercial distributor provides access to the motion-picture to the plurality of participants.

9. The motion-picture discussion event packet of claim 8 wherein the distributor provides access to the motion-picture by providing the plurality of participants with a link to a site on a network where an electronic copy of the motion-picture can be accessed.

10. The motion-picture discussion event packet of claim 8 wherein the distributor provides access to the motion-picture by providing the plurality of participants with a password for accessing an electronic copy of the motion-picture.

11. The motion-picture discussion event packet of claim 1 wherein the motion-picture scheduled is selected from a preference list of motion-pictures provided to a commercial distributor of motion-pictures and further comprising an inventory management system that determines whether a sufficient quantity of the nth motion-picture, in order of preference, is available for the plurality of participants.

12. The motion-picture discussion event packet of claim 11 wherein the distribution apparatus further comprises a plurality of media mailers for distributing media copies of the motion-picture to the plurality of participants.

13. The motion-picture discussion event packet of claim 2 further comprising access to trivia questions and answers concerning the motion-picture.

14. The motion-picture discussion event packet of claim 1 further comprising access to a host manual providing instructions on hosting a motion-picture discussion event.

15. A method for holding a motion-picture discussion event comprising:
scheduling a motion-picture to be the topic of a motion-picture discussion event;
providing a plurality of accesses to the motion-picture;
providing a plurality of accesses to a list of topics for discussion during the motion-picture discussion event, the topics being related to the motion-picture; and
distributing at least one access to the motion-picture to each of a plurality of participants in the motion picture discussion event;
distributing at least one access to the list of topics to each of the plurality of participants in the motion picture discussion event.

16. The method of claim 15 wherein distributing at least one access to the motion-picture comprises providing access to a media copy of the motion-picture.
